(19) United States
(12) Patent Application Publication
(10) Pub. No.: US 2026/0081265 A1
(43) Pub. Date: Mar. 19, 2026

(54) Cylindrical Battery Cell Housing with Intrinsic Pressure Relief Means

(71) Applicants: Martin Christoph Lentz, Bonn (DE); Holger Aretz, Spessart (DE)

(72) Inventors: Martin Christoph Lentz, Bonn (DE); Holger Aretz, Spessart (DE)

(73) Assignee: Speira GmbH, Grevenbroich (DE)

(21) Appl. No.: 19/394,143

(22) Filed: Nov. 19, 2025

Related U.S. Application Data
(63) Continuation of application No. PCT/EP2024/064161, filed on May 23, 2024.

(30) Foreign Application Priority Data
May 24, 2023 (EP) 23175202.3

(51) Int. Cl. H01M 50/107; H01M 50/119; H01M 50/133; H01M 50/148; H01M 50/152; H01M 50/159; H01M 50/169; H01M 50/342

(52) U.S. Cl. CPC H01M 50/107; H01M 50/119; H01M 50/133; H01M 50/152; H01M 50/154; H01M 50/159; H01M 50/169; H01M 50/3425; H01M 2200/10

(57) ABSTRACT

A cylindrical battery cell housing of a battery cell with a battery cell housing jacket has a first material made of an aluminium alloy with a cylindrical cross-section at least in areas. The battery cell housing jacket is connected to a battery cell housing lid having a second material made of an aluminium alloy in a force-fitting and/or materially bonded manner. The battery cell housing lid is designed as a sheet metal cut-out, which serves as a pressure relief means for the battery cell housing. In the event that the permissible internal pressure of the battery cell housing is exceeded, the battery cell housing lid ensures pressure relief of the battery cell in the axial direction.

### CROSS-REFERENCE TO RELATED PATENT APPLICATIONS

This patent application is a continuation of International Application No. PCT/EP2024/064161, filed on May 23, 2024, which claims the benefit of priority to European Patent Application No. 23175202.3, filed May 24, 2023, the entire teachings and disclosures of both applications are incorporated herein by reference thereto.

### FIELD OF THE INVENTION

The present invention relates to a cylindrical battery cell housing of a battery cell with a battery cell housing jacket having a first material made of an aluminium alloy with a cylindrical cross-section at least in areas.

### BACKGROUND OF THE INVENTION

Battery cells are used in a variety of technical applications to supply an electrical consumer with electrical energy. In particular, fields of application for lithium-ion (Li) secondary battery cells, hereinafter referred to as battery cells are, for example, in electromobility, particularly in electric cars, electric bicycles and electric scooters, in consumer electronics, in laptop computers, tablet computers, mobile phones, digital cameras and video cameras, or in energy technology, particularly in battery storage, to name just a few. A plurality of battery cells are often connected together in series or parallel to form a battery module, or a battery system.

A widely used format of battery cell housings is cylindrical battery cell housings, which, as the name suggests, have a cylindrical shape and are available in different diameters and sizes. In principle, in applications with high charging capacity, there is a tendency to increase the volumes of the battery cells in order to increase the energy densities of battery modules through the higher energy storage capacity of the individual battery cell.

The dominant round battery cell format with cylindrical battery cell housings corresponds to round battery cells of type 18650 with a diameter of 18 mm. In various applications, these are being replaced with round battery cells of type 21700 with a diameter of 21 mm. Moreover, substitution of round battery cells of the type 46800 with a diameter of 46 mm for round battery cells of the type 21700 is already to be expected, for example in the field of electromobility. The increasing cell formats are placing demands on the removal of the heat generated inside the round battery cell and therefore on the electrical and thermal conductivities of the battery cell housing.

The electrolyte containing lithium that is predominantly used is usually highly reactive. Gases can therefore be released inside the battery due to chemical reactions, for example in the event of malfunctions, faulty control, mechanical damage or improper use, which can increase the internal pressure in the battery cell housing in an inadmissible manner. If no suitable safety mechanisms are provided, this can result in a significant increase in temperature and, in the worst case, thermal runaway of the individual cell. If the battery cell housing jacket is damaged during the pressure increase in combination with a temperature increase due to exothermic reactions inside the battery cell, hot or burning gases escape via the jacket surface of the battery cell. This can, for example, result in the destruction of the entire battery module in the case of battery cell modules that have a plurality of battery cells and the battery cell housing jackets of which are arranged at a very small distance from each other. Thermal runaway spreads from the individual cell to other cells, the affected module or the entire battery, which usually leads to the battery catching fire. Lithium-ion battery fires cannot be extinguished with conventional means. Thermal runaway must therefore be prevented by all means.

For this purpose, cylindrical battery cell housings have a battery cell housing lid with a complex structure as a safety device, which, in addition to the electrical battery contact, can in particular have an electrically conductive current interruption device, for example in the form of a punched or embossed metallic disc, which, on the one hand, can cause a current interruption due to a deformation under a specific pressure load from the inside of the battery cell and/or can burst at an even higher internal pressure in order to release the gases within the battery via the battery contact in the axial direction of the battery cell housing. This prevents destruction of the battery cell housing jacket and thus of other battery cells. FIG. 1 shows a structure of a battery cell housing lid of this type in a schematic sectional view.

As shown in FIG. 1, the current interruption disc can be crimped onto the electrical contact of the battery cell. The crimped combination of the current interruption disc and the electrical contact of the battery cell is in turn crimped to the battery cell housing jacket, with the option of crimping additional safety devices, such as a PTC (positive thermal coefficient) switch, either to the battery cell housing jacket or to the electrical contact and the current interruption disc. This double crimp connection of the battery cell housing lid is complex and prone to errors. At the same time, the complex battery cell housing lid with the safety devices occupies a relatively large volume of the battery cell.

A prismatic battery cell with a safety valve for pressure compensation in the lid of the battery cell housing is known from the Chinese utility model CN 205564827 U.

The Japanese patent application JP 200393059 A resolves the problem of possible deformation of the battery cell housing due to increased internal pressure by providing a multi-layer composite material that provides both the high strengths and good weldability of the batteries. No pressure relief means are disclosed.

US patent application US 2019/0368008 A1 discloses an aluminium alloy for a “battery component”, wherein the battery component refers to a “mesh” as a current collector.

### SUMMARY OF THE INVENTION

The object of the present invention is therefore to provide a battery cell housing that not only allows for a simpler structure and a greater battery capacity within the same size of the battery cell but also offers a high level of protection against the destruction of the battery cell housing and consequently prevents the spread of thermal runaway to other battery cells.

According to a first teaching of the present invention, the object shown is achieved in that the battery cell housing jacket is connected to at least one battery cell housing lid having a second material made of an aluminium alloy in a force-fitting and/or materially bonded manner, wherein the at least one battery cell housing lid is formed as a sheet metal cut-out, and the sheet metal cut-out is designed as a pressure relief means for the battery cell housing due to its mechanical properties, wherein in the event of exceeding a permissible internal pressure of the battery cell, preferably exclusively, the least one battery cell housing lid ensures pressure relief of the battery cell in the axial direction. The sheet metal cut-out of the battery cell housing lid is preferably circular.

Simulations have shown that a suitable selection of materials for the battery cell housing jacket and the battery cell housing lid, both of which have aluminium alloys, allows the battery cell housing lid to intrinsically function as a pressure relief means due to its mechanical properties. The mechanical properties of the sheet metal cut-out result from the composition of the aluminium alloy and the tempering condition of the sheet metal cut-out. It has been shown that the battery cell housing lid in the form of a sheet metal cut-out reliably relieves the pressure of the battery cell in the axial direction under these conditions without damaging the battery cell housing jacket. As the battery cell housing lid provides pressure relief, it is possible to forgo a complex design of the lid, particularly a rupture disc inside the battery cell, while still achieving a high level of safety against thermal runaway. The simplified design of the battery cell housing lid as a sheet metal cut-out allows for an increase in the volume of the battery cell housing available for storing electrical energy, thereby achieving a greater battery capacity.

According to a first embodiment, the material of the battery cell housing jacket differs from the material of the at least one battery cell housing lid in the temper state of the aluminium alloy and/or in the alloy composition. In this way, different mechanical properties of the battery cell housing jacket and the battery cell housing lid can be provided so that the pressure is relieved exclusively via the battery cell housing lid in the event of an average.

The at least one battery cell housing lid according to a further embodiment is preferably materially bonded to the battery cell housing jacket by means of a weld seam, preferably by means of a laser weld seam. As a result, a high-density connection can be provided between the battery cell housing lid and the battery cell housing jacket, which reliably protects the inside of the battery cell against external influences and can simultaneously be manufactured in a highly automated manner. Laser weld seams are characterised by exceptionally high precision and minimal impact on the joining materials, ensuring that the material properties remain largely unaffected, even in the vicinity of the weld seam.

To determine suitable materials for the battery cell housing jacket and the battery cell housing lid, ensuring that only the battery cell housing lid provides pressure relief in the axial direction of the battery cell in the event of an excessively high internal pressure within the battery cell, it was initially assumed that the specific deformation work required for the failure of the battery cell housing lid must be less than that for the failure of the material of the battery cell housing jacket.

The specific deformation work up to uniform elongation is approximated A_{g} via a trapezoidal surface in the stress-strain diagram as follows:

$${\int }_{0}^{{A}_{g}} s ( {e}_{p} ) {de}_{p} \approx \frac{{R}_{p 0.2} + {R}_{m}}{2} \cdot {A}_{g} \qquad ( 1 )$$

where s(eₚ) the technical stress and eₚ the technical plastic elongation in the uniaxial tensile test are represented as well as s(0)=R_{p0.2} the yield strength and s(A_{g})=Rₘ the tensile strength.

The following condition to be fulfilled for the material of the battery cell housing lid D and the material of the battery cell housing jacket M is formulated as follows:

$${( \frac{{R}_{p 0.2} + {R}_{m}}{2} \cdot {A}_{g} )}_{D} < {( \frac{{R}_{p 0.2} + {R}_{m}}{2} \cdot {A}_{g} )}_{M} \qquad ( 2 )$$

This inequation states that the specific deformation work required to plastically deform the respective material up to uniform elongation should have a lower value for the lid than for the jacket. It should therefore be easier to cause the plastic failure of the lid than of the jacket.

In this embodiment, materials for the battery cell housing lid that fulfil the equation (2) are excluded if they primarily deform elastically, meaning that plastic deformation of the battery cell housing jacket may still occur despite condition (3). With the other condition to be fulfilled

$${( {R}_{p 0.2} )}_{D} < {( {R}_{p 0.2} )}_{M} \qquad ( 3 )$$

plastic deformation of the battery cell housing jacket is ruled out.

Equation (2) can now be (R_{p0.2})_{D} resolved according to and in combination with equation (3). Consequently, the yield strength of the material of at least one battery cell housing lid (R_{p0.2})_{D} of this embodiment of the invention satisfies the following condition:

$${( {R}_{p 0.2} )}_{D} < {( {R}_{p 0.2} )}_{D , perm} \qquad ( 4 a )$$

with the maximum permissible yield strength for the lid

$${( {R}_{p 0.2} )}_{D , perm} : = min \{ {( {R}_{p 0.2} )}_{M} ; {( {R}_{p 0.2} )}_{M} \cdot ( \frac{{( {A}_{g} )}_{M}}{{( {A}_{g} )}_{D}} ) + \frac{{( {R}_{m} \cdot {A}_{g} )}_{M} - {( {R}_{m} \cdot {A}_{g} )}_{D}}{{( {A}_{g} )}_{D}} \} \qquad ( 4 b )$$

and
(R_{p0.2}): Yield strength of the battery cell housing jacket,
(A_{g})_{M}: Uniform elongation of the battery cell housing jacket,
(A_{g})_{D}: Uniform elongation of the battery cell housing lid,
(Rₘ·A_{g})_{M}: Product of tensile strength and uniform elongation of the battery cell housing jacket.
(Rₘ·A_{g})_{D}: Product of tensile strength and uniform elongation of the battery cell housing lid.

In this embodiment, an upper limit is established for the yield strength of the material of the battery cell housing lid (R_{p0.2})_{D} based on the material properties of the uniform elongation A_{g}, the tensile strength Rₘ of the battery cell housing lid and the battery cell housing jacket and the yield strength of the battery cell housing jacket (R_{p0.2})_{M}. The resulting material combinations make it possible to provide a battery cell housing lid that guarantees exclusive pressure relief in the event of excessive internal pressure.

Internal pressures can be defined for battery cells at which exceeding these pressures should prevent the battery cell from being destroyed by means of targeted pressure relief in the axial direction, thus preventing the occurrence of thermal runaway.

In the further analysis, the cylindrical battery cell housing is approached by a closed tube. The tubular body corresponds to the battery cell housing jacket in terms of wall thickness s_{M} and inner radius Rᵢ. The tube ends correspond to the battery cell housing lids in terms of wall thickness s_{D}. The materially bonded connection of the battery cell housing lid to the battery cell housing jacket is considered mechanically as a fixed clamping of the battery cell housing lid such that the stress components specified for such a tubular body in Table 1 can be defined:

TABLE 1

| Component | σᵣ | σ_{φ} | σ_{z} | σ_{V,T} |
|---|---|---|---|---|
| Lid (on the edge) | $\frac{3}{4} \cdot p \cdot {( \frac{{R}_{i}}{{s}_{D}} )}^{2}$ | $0.225 \cdot p \cdot {( \frac{{R}_{i}}{{s}_{D}} )}^{2}$ | −p | σᵣ − σ_{z} ≈ σᵣ |
| Jacket | −p | $\frac{p \cdot {R}_{i}}{{s}_{M}}$ | $\frac{p \cdot {R}_{i}}{2 \cdot {s}_{M}}$ | σ_{φ} − σᵣ ≈ σ_{φ} |

In Table 1, σᵣ represents the stress in the radial direction, σ_{φ} represents the stress in the circumferential direction, σ_{z} represents the stress in the axial direction, and σ_{V,T} represents the equivalent stress according to Tresca (see “Dubbel Taschenbuch für den Maschinenbau”, Volume 1, Part II Mechanics, 26th edition, Springer Verlag, 2020).

For given permissible internal pressures pₚₑᵣₘ, advantageous wall thicknesses for the battery cell housing lid can now be specified when specifying the wall thicknesses and the material of the battery cell housing jacket. For this purpose, it is initially assumed that a start of flow in the battery cell housing lid should be permitted in such a way that it is plastically deformed. The equivalent stress according to Tresca (σ_{V,T})_{D} for the battery cell housing lid may therefore reach a maximum value equal to the yield strength (R_{p0.2})_{D} of the battery cell housing lid. Accordingly:

$${( {σ}_{V , T} )}_{D} \leq {( {R}_{p 0.2} )}_{D} . \qquad ( 5 )$$

At the same time, the battery cell housing jacket must not deform plastically. The equivalent stress according to Tresca (σ_{V,T})_{M} of the battery cell housing jacket must therefore be less than the yield strength of (R_{p0.2})_{M} the battery cell housing lid:

$${( {σ}_{V , T} )}_{M} < {( {R}_{p 0.2} )}_{M} . \qquad ( 6 )$$

Finally, it is necessary to ensure that the battery cell housing jacket remains undamaged. This results in the following condition for the equivalent stresses according to Tresca (σ_{V,T})_{D} and (σ_{V,T})_{M} for the battery cell housing lid and jacket:

$${( {σ}_{V , T} )}_{D} > {( {σ}_{V , T} )}_{M} . \qquad ( 7 )$$

The following estimate is made from the inequation (5) by multiplying with (R_{p0.2})_{M} and applying the inequation (6):

$${( {σ}_{V , T} )}_{D} \cdot {( {σ}_{V , T} )}_{M} < {( {σ}_{V , T} )}_{D} \cdot {( {R}_{p 0.2} )}_{M} \leq {( {R}_{p 0.2} )}_{D} \cdot {( {R}_{p 0.2} )}_{M} \qquad ( 8 )$$

The following condition for the pressure p can be derived from this with the stress components from Table 1:

$$p < + \sqrt{\frac{4}{3} \cdot \frac{{s}_{D}^{2} \cdot {s}_{M}}{{R}_{i}^{3}} \cdot ( {( {R}_{p 0.2} )}_{D} \cdot {( {R}_{p 0.2} )}_{M} )} \qquad ( 9 )$$

Similarly, the following estimate is obtained from the inequation (7) by multiplying by (σ_{V,T})_{D} using the inequation (6):

$${( {R}_{p 0.2} )}_{D}^{2} \geq {( {σ}_{V , T} )}_{D}^{2} > {( {σ}_{V , T} )}_{M} \cdot {( {σ}_{V , T} )}_{D} . \qquad ( 10 )$$

By inserting the stress components from Table 1, the following is obtained for the pressure p:

$$p < + \sqrt{\frac{4}{3} \cdot \frac{{s}_{D}^{2} \cdot {s}_{M}}{{R}_{i}^{3}} \cdot {( {R}_{p 0.2} )}_{D}^{2}} \qquad ( 11 )$$

Inequations (9) and (11) must be fulfilled simultaneously. This results in the following estimate for the maximum permissible internal pressure pₚₑᵣₘ:

$$p < {p}_{perm} \qquad ( 12 a )$$

$${p}_{p e r m} := + \sqrt{\frac{4}{3} \cdot \frac{{s}_{D}^{2} \cdot {s}_{M}}{{R}_{i}^{3}}} \cdot min \{ {( {R}_{p 0.2} )}_{D} ; \sqrt{{( {R}_{p 0.2} )}_{D} \cdot {( {R}_{p 0.2} )}_{M}} \} \qquad ( 12 b )$$

According to inequation (5), it was assumed that the battery cell housing lid was subjected to load up to the start of flow. In fact, however, the battery cell housing lid should be subjected to load until failure in order to relieve pressure. In the single-axis tensile test, the tensile strength Rₘ is characterised by the start of the narrowing and is suitable as a load limit for the battery cell housing lid. The true tensile strength is σₘ calculated from Rₘ as follows:

$${σ}_{m} = {R}_{m} \cdot ( 1 + {A}_{g} ) \qquad ( 13 )$$

where
Rₘ: Tensile strength,
A_{g}: Uniform elongation.

By replacing (R_{p0.2})_{D} with (σm)_{D}, the following is obtained for the permissible pressure pₚₑᵣₘ from equation (12b):

$${p}_{perm} = \text{} + \sqrt{\frac{4}{3} \cdot \frac{{s}_{D}^{2} \cdot {s}_{M}}{{R}_{i}^{3}}} \cdot min \{ {( {R}_{m} \cdot ( 1 + {A}_{g} ) )}_{D} ; \sqrt{{( {R}_{m} \cdot ( 1 + {A}_{g} ) )}_{D} \cdot {( {R}_{p 0.2} )}_{M}} \} \qquad ( 14 )$$

From equation (14), an advantageous specification of the wall thickness s_{D} of the battery cell housing lid can now be made for a further embodiment of the battery cell housing. The following applies to the wall thickness s_{D} of the battery cell housing lid, depending on the mechanical properties (R_{p0.2})_{M} and (Rₘ·(1+A_{g}))_{D} as well as the wall thickness of the battery cell housing jacket s_{M} at a given internal pressure p*=pₚₑᵣₘ, where p* is the internal pressure in the battery cell housing at which the lid fails as intended:

$${s}_{D} = \sqrt{\frac{3}{4} \cdot \frac{{R}_{i}^{3}}{{s}_{M}}} \cdot ( \frac{{p}^{*}}{min \{ {( {R}_{m} \cdot ( 1 + {A}_{g} ) )}_{D} ; \sqrt{{( {R}_{m} \cdot ( 1 + {A}_{g} ) )}_{D} \cdot {( {R}_{p 0.2} )}_{M}} \}} ) \qquad ( 15 )$$

where
s_{M}: Wall thickness of the battery cell housing jacket,
s_{D}: Wall thickness of the battery cell housing lid,
p*: Specified internal pressure in the battery cell housing at the time of failure of the lid,
Rₘ: Tensile strength,
A_{g}: Uniform elongation,
D: Index of the battery cell housing lid,
M: Index of the battery cell housing jacket.

With these wall thicknesses s_{M}, plastic deformation of the battery cell housing jacket can be ruled out.

To account for the anisotropy of the plastic properties of the sheet metal materials, mean values (R_{p0.2})_{avg}, (Rₘ)_{avg} and (A_{g})_{avg} for the yield strength R_{p0.2}, tensile strength Rₘ and uniform elongation A_{g} in the three directions of 0°, 45°, and 90° relative to the rolling direction, as per the relationship known from sheet metal forming

$${X}_{avg} = \frac{1}{4} \cdot ( {X}_{{0}^{∘}} + 2 {X}_{{45}^{∘}} + {X}_{{90}^{∘}} )$$

are preferably considered in equations (4a), (4b), (14), and (15), wherein the value at 45° must be counted twice in the calculation of the mean value, and “X” serves as a placeholder for one of the quantities R_{p0.2}, Rₘ or A_{g}.

According to a further embodiment of the battery cell housing, the lid designed for pressure relief activates the pressure relief of the battery cell housing at an internal pressure ranging from 0.5 MPa (5 bar) to 2.5 MPa (25 bar), preferably from 0.7 MPa to 2.0 MPa (7 to 20 bar), particularly preferably from 0.7 MPa to 1.5 MPa (7 to 15 bar). This prevents major damage in a battery module, for example due to an explosion-like pressure relief, as the pressure relief is triggered safely in the axial direction even at moderate internal pressures.

A sufficiently stable battery cell housing jacket can be provided according to a subsequent embodiment of the battery cell housing in which the battery cell housing jacket has a yield strength R_{p0.2} of more than 100 MPa, preferably more than 150 MPa, particularly preferably more than 180 MPa. Especially with the preferred yield strength values, it has been shown that the choice of material for the battery cell housing lid increases.

According to a subsequent embodiment of the battery cell housing, the battery cell housing jacket has an aluminium wrought alloy, preferably an aluminium wrought alloy of type AA3xxx. To provide the highest strengths, an aluminium wrought alloy of type AA5xxx can also be used for the battery cell housing jacket. Due to their microstructure, wrought aluminium alloys have preferred properties in terms of density and ductility over cast aluminium materials. The aluminium alloy of type AA3xxx is characterised by high strengths and good welding and corrosion properties. For example, the aluminium alloy types AA3004, AA3104, AA3005 or AA3105 are characterised by a particularly high level of recyclability with possible recycling percentages of more than 70%, preferably more than 90%.

A particularly high recycling potential, with recycled metal content exceeding 90%, can be achieved while simultaneously achieving other essential properties such as good formability, high yield strength, excellent weldability and good corrosion resistance, by using an aluminium alloy for the battery cell housing jacket that has the following alloy composition expressed in wt %:
0.1%≤Si≤0.5%, preferably 0.2%≤Si≤0.4%,
0.20%≤Fe≤0.8%, preferably 0.40%≤Fe≤0.6%,
Cu≤0.6%, preferably 0.10%≤Cu≤0.30%,
0.3%≤Mn≤1.4%, preferably 0.50%≤Mn≤1.1%,
0.01%≤Mg≤1.5%, preferably 0.05%≤Mg≤1.30% or preferably 0.30%≤Mg≤1.20%,
Cr≤0.25%, preferably Cr≤0.1%,
Zn≤0.4%,
Ti≤0.2%, preferably 0.005 wt %≤Ti≤0.1 wt % or preferably 0.005 wt %≤Ti≤0.05 wt %
the remainder being Al and unavoidable impurities, individually at most 0.05% and in total at most 0.15%.

The silicon content of the aluminium alloy is preferably in the range of 0.1 wt %≤Si≤0.5 wt %. In one embodiment of the battery cell housing, the silicon content of the aluminium alloy is in the range of 0.2 wt %≤Si≤0.4 wt %. In combination with the iron and manganese contents in the amounts specified, the silicon content of 0.1 wt %≤Si≤0.5 wt % leads in particular to relatively uniformly distributed, compact particles of the quaternary α-Al(Fe,Mn)Si phase. These precipitated particles increase both the strength of the aluminium alloy and its electrical and thermal conductivity, since they remove iron and manganese from the solid solution without detrimentally affecting other properties such as corrosion behaviour or formability. Silicon contents of less than 0.1 wt % lead to reduced precipitation of α-Al(Fe,Mn)Si phases, which may impair the electrical and thermal conductivity because of dissolved manganese. Furthermore, the absence of α-Al(Fe,Mn)Si phases has a detrimental effect on tool wear. Silicon contents of more than 0.5 wt % may lead in combination with magnesium to the formation of Mg₂Si phases, which detrimentally affects the solid solution hardening of magnesium. The corridor of the silicon content of the preferred embodiment of 0.2 wt %≤Si≤0.4 wt % represents an ideal compromise between high strength and high electrical and thermal conductivity. The iron content of the aluminium alloy is preferably in the range of 0.2 wt %≤Fe≤0.8 wt %. In a preferred embodiment of the battery cell housing, the iron content of the aluminium alloy is in the range of 0.4 wt %≤Fe≤0.6 wt %. The iron content of 0.2 wt %≤Fe≤0.8 wt % in combination with the manganese content in the amount specified leads to the formation of Al₆(Mn,Fe) phases and, as already explained above, in combination with the silicon and manganese contents in the amounts specified to the precipitation of particles of the quaternary α-Al(Fe,Mn)Si phase. Iron in this case contributes to lowering the solubility of manganese in aluminium, so that more manganese is bound in intermetallic phases, which has a positive effect on the electrical and thermal conductivity. Moreover, the intermetallic phases influence recovery and recrystallisation processes and improve the thermal stability of the mechanical properties. Iron contents of more than 0.8 wt % promote the formation of coarse intermetallic phases, which may impair the formability in the deep drawing process. Iron contents of less than 0.2 wt %, on the other hand, limit the tolerance of the aluminium alloy for ferrous scrap too greatly since conventional scrap grades generally have a significant proportion of iron. Limiting the iron content too greatly may therefore hinder the achievement of high recycling rates. The preferred range of the iron content of the embodiment of 0.4 wt %≤Fe≤0.6 wt % therefore represents an ideal combination of recyclability. i.e. the use of high proportions of recycled material, thermal stability, electrical and thermal conductivity and formability.

The copper content of the aluminium alloy is preferably in the range of Cu≤0.6 wt %. In a preferred embodiment of the battery cell housing, the copper content of the aluminium alloy is in the range of 0.1 wt %≤Cu≤0.3 wt %. The fact that a copper content of up to 0.6 wt % is permitted results in an increased tolerance of the aluminium alloy for copper-containing aluminium alloy scrap, which promotes the achievement of high proportions of recycled material in the manufacture of the battery cell housing. However, since excessively high copper contents may have a detrimental effect on the corrosion properties, the copper content is limited according to the invention to at most 0.6 wt % in order to achieve a sufficiently high electrolyte stability. For improved electrolyte stability and sufficiently high electrical and thermal conductivity, the copper content in the aforementioned embodiment is limited to 0.3 wt %. However, the presence of copper also causes an increase in the strength of the aluminium alloy by solid solution hardening, although this only becomes significant above a content of 0.1 wt %. A preferred range of 0.1 wt %≤Cu≤0.3 wt % therefore represents a compromise between high strength, sufficiently high electrical and thermal conductivity and further improved electrolyte stability with sufficient recycling tolerance.

The manganese content of the aluminium alloy is preferably in the range of 0.3 wt %≤Mn≤1.4 wt %. In one embodiment of the battery cell housing according to the invention, the manganese content of the aluminium alloy is in the range of 0.5 wt %≤Mn≤1.1 wt %. As already explained above, the manganese content of 0.3 wt %≤Mn≤1.4 wt %, or 0.5 wt %≤Mn≤1.1 wt % in combination with the silicon and iron contents in the amounts specified leads to the precipitation of particles of the quaternary α-Al(Fe,Mn)Si phase as well as the Al₆(Mn,Fe) phase. The intermetallic phases hinder recovery and recrystallisation processes and therefore improve the thermal stability of the mechanical properties. Manganese contents of less than 0.3 wt % already reduce the increase in strength by dispersoid and solid solution hardening. Manganese contents of less than 0.3 wt % lead to an insufficient increase in strength due to dispersoid and solid solution hardening, whereas manganese contents of more than 1.1 wt %, in particular more than 1.4 wt %, promote the formation of coarse intermetallic phases, which have an unfavourable effect on the forming properties in the deep drawing process. In addition, manganese contents of more than 1.1 wt %, in particular more than 1.4 wt %, reduce the electrical and thermal conductivity of the battery cell housing so greatly that the thermal management becomes inefficient.

The magnesium content of the aluminium alloy is in the range of 0.01 wt %≤Mg≤1.5 wt %. In one embodiment of the battery cell housing according to the invention, the magnesium content of the aluminium alloy is in the range of 0.05 wt %≤Mg≤1.3 wt %, preferably 0.3 wt %≤Mg≤1.2 wt %. The fact that a magnesium content of up to 1.5 wt % is permitted results in an increased tolerance of the aluminium alloy for aluminium alloy scrap containing magnesium such as UBC (used beverage can) scrap, which further promotes the achievement of high proportions of recycled material in the manufacture of the battery cell housings. In addition, the presence of magnesium above a content of 0.05 wt % leads to efficient solid solution hardening, which contributes to increased cold hardening and therefore increases the strength. However, since excessively high magnesium contents have a detrimental effect on the electrical and thermal conductivity, the magnesium content is limited to a maximum of 1.5 wt %. In order to achieve improved mechanical properties, the magnesium content in the aforementioned embodiment is preferably increased to at least 0.05 wt %, in particular to at least 0.3 wt %. The preferred range of 0.3%≤Mg≤1.2% in combination with cold hardening enables sufficiently high strength to prevent tearing of the battery cell housing jacket.

The chromium content of the aluminium alloy is preferably in the range of Cr≤0.25 wt %. In one embodiment of the battery cell housing, the chromium content of the aluminium alloy is in the range of Cr≤0.1 wt %. The fact that a chromium content of up to 0.25 wt % is permitted results in an increased tolerance of the aluminium alloy for chromium-containing aluminium alloy scrap, which promotes the achievement of high proportions of recycled material in the manufacture of the battery cell housings. In addition, chromium also has a strength-increasing effect and forms dispersoids, which increase the thermal stability and hinder softening due to recrystallisation or recovery. However, since excessively high chromium contents may have a detrimental effect on the electrical conductivity of the aluminium alloy, the chromium content is limited to a maximum of 0.25 wt %. For improved conductivity with a recycling tolerance and strength that are still sufficient, the chromium content in a preferred embodiment is limited to 0.1 wt %.

The zinc content of the aluminium alloy is preferably in the range of Zn≤0.4 wt %. The fact that a zinc content of up to 0.4 wt % is permitted results in an increased tolerance of the aluminium alloy for zinc-containing aluminium alloy scrap, which further promotes the achievement of high recycling rates. Zinc also has a strength-increasing effect. However, since excessively high zinc contents reduce the weldability, the electrical and thermal conductivity as well as the corrosion resistance of the aluminium alloy, the zinc content is limited according to the invention to at most 0.4 wt %.

The titanium content of the aluminium alloy is preferably in the range of Ti≤0.2 wt %. In one embodiment of the battery cell housing, the titanium content of the aluminium alloy is in the range of 0.005 wt %≤Ti≤0.1 wt %, preferably 0.005 wt %≤Ti≤0.05 wt %. The fact that a titanium content of up to 0.2 wt % is permitted results in an increased tolerance of the aluminium alloy for titanium-containing aluminium alloy scrap, which promotes the achievement of high proportions of recycled material in the manufacture of battery cell housings. Excessively high titanium contents may detrimentally affect the forming properties of the aluminium alloy and significantly reduce the electrical and thermal conductivities, however, so that the titanium content is limited according to the invention to at most 0.2 wt %.

In addition to the alloy composition mentioned above, the remainder of the aluminium alloy of the battery cell housing according to this exemplary embodiment consists of aluminium and unavoidable impurities. Unavoidable impurities are alloy constituents that are not intentionally added but are inevitably contained in the aluminium alloy due to manufacturing.

The content of an individual unavoidable impurity is limited to 0.05 wt % and the content of all unavoidable impurities is limited to a total of 0.15 wt %. This ensures that the unavoidable impurities have no detrimental effect, or no significant detrimental effects, on the properties of the aluminium alloy, for example by undesired phase formation.

If maximum strength of the battery cell housing jacket is desired, the use of a wrought alloy of type AA5xxx is advantageous. High strength combined with adequate weldability for the sealing weld of the battery cell housing jacket to the battery cell housing lid can be achieved by using an aluminium alloy in the battery cell housing jacket that contains the following alloy composition in wt %:
Si<0.3%,
Fe<0.4%,
Cu<0.2%,
Mn<0.8%,
2.5%<Mg<6.0%, preferably 3%<Mg<6.0%,
Cr<0.2%,
Zn<0.25%,
Ti≤0.15%, preferably 0.001%≤Ti≤0.1%,
the remainder being Al and unavoidable impurities, individually at most 0.05% and in total at most 0.15%.

Because of the high achievable strengths, battery cell housing jackets made of AA5xxx alloys can fulfil demanding load requirements and therefore be considered, for example, as structural components in vehicles. The magnesium content of more than 2.5 wt %, preferably more than 3.0 wt %, is responsible for the increase in the strength. Furthermore, with these magnesium contents the maximum hot cracking tendency of the aluminium alloy during welding is already exceeded, so magnesium contents of more than 2.5 wt %, preferably more than 3.0 wt %, enable an efficient welding process. With at least 6.0 wt %, processing of the aluminium alloy by cold rolling becomes increasingly difficult since the solidification increases greatly during cold rolling and the susceptibility to intercrystalline corrosion rises greatly. Silicon contents of less than 0.3 wt % are preferable in order to minimise the hot cracking tendency during the welding process and to avoid the formation of Mg₂Si phases, which remove magnesium from the solid solution and therefore reduce the solid solution hardening. Iron is present as an impurity in industrial primary metal and through recycling. Iron contents of less than 0.4 wt % lead, in combination with manganese contents of less than 0.8 wt %, to the formation of AlMnFe phases, which as dispersoids contribute to efficient control of the recrystallisation and recovery and therefore allow optimisation of the grain structure. Higher iron contents may lead to the formation of coarse intermetallic phases, whereas manganese contents above 0.8 wt % significantly reduce thermal and electrical conductivity. As a dispersoid former, chromium contributes to control of the microstructure in recovery and recrystallization processes and to stabilisation of the microstructure under thermal stress. However, chromium impairs the electrical and thermal conductivity, so the chromium content is limited to less than 0.2 wt %. Zinc impairs the corrosion resistance and is therefore limited to less than 0.25 wt %. Titanium is used for grain refining or in order to optimise the casting structure during the casting process. However, titanium reduces the electrical and thermal conductivity comparatively strongly, so the titanium content is preferably limited to a maximum of 0.15 wt %, more preferably 0.001 wt %≤Ti≤0.1 wt %.

If the at least one battery cell housing lid has an aluminium wrought alloy of type AA1xxx, AA8xxx or AA3xxx according to a further embodiment of the battery cell housing, preferred mechanical properties of the battery cell housing lid can be achieved with conventional alloys. The material of the battery cell housing lid preferably has the temper state H24, H14, H18 or H19. Under these hard-rolled conditions, the strengthening capacity of the aluminium alloy in the material is limited, resulting in precisely adjustable axial pressure relief achieved through the failure of these materials.

The battery cell housing lid preferably has an aluminium alloy having the following alloy composition in wt %:
0.1%≤Si≤0.5%,
Fe≤0.8%, preferably 0.20%≤Fe≤0.8%,
Cu≤0.3%,
Mn≤1.4%,
0.005%≤Mg≤0.8%, preferably 0.01%≤Mg≤0.5%,
more preferably 0.01%≤Mg≤0.3%,
Cr≤0.25%,
Zn≤0.4%,
Ti≤0.2%, preferably 0.005 wt %≤Ti≤0.1 wt %, or preferably 0.005 wt %≤Ti≤0.05 wt %
the remainder being Al and unavoidable impurities, individually at most 0.05% and in total at most 0.15%.

The silicon content of the aluminium alloy is preferably in the range of 0.1 wt %≤Si≤0.5 wt %. In one embodiment of the battery cell housing lid, the silicon content of the aluminium alloy is in the range of 0.2 wt %≤Si≤0.4 wt %. In combination with the iron and manganese contents in the amounts specified, the silicon content of 0.1 wt %≤Si≤0.5 wt % leads in particular to relatively uniformly distributed, compact particles of the quaternary α-Al(Fe,Mn)Si phase. These precipitated particles increase both the strength of the aluminium alloy and its electrical and thermal conductivity, since they remove iron and manganese from the solid solution without detrimentally affecting other properties such as corrosion behaviour or formability. Silicon contents of less than 0.1 wt % lead to reduced precipitation of α-Al(Fe,Mn)Si phases, which may impair the electrical and thermal conductivity because of dissolved manganese. Furthermore, the absence of α-Al(Fe,Mn)Si phases has a detrimental effect on tool wear. Silicon contents of more than 0.5 wt % may lead in combination with magnesium to the formation of Mg₂Si phases, which detrimentally affects the solid solution hardening of magnesium. The corridor of the silicon content of the aforementioned embodiment of 0.2 wt %≤Si≤0.4 wt % represents an ideal compromise between high strength and high electrical and thermal conductivity.

The iron content of the aluminium alloy is preferably in the range of 0.2 wt %≤Fe≤0.8 wt %. In an embodiment of the battery cell housing lid, the iron content of the aluminium alloy is in the range of 0.4 wt %≤Fe≤0.6 wt %. The iron content of 0.2 wt %≤Fe≤0.8 wt % in combination with the manganese content in the amount specified leads to the formation of Al₆(Mn,Fe) phases and, as already explained above, in combination with the silicon and manganese contents in the amounts specified to the precipitation of particles of the quaternary α-Al(Fe,Mn)Si phase. Iron in this case contributes to lowering the solubility of manganese in aluminium, so that more manganese is bound in intermetallic phases, which has a positive effect on the electrical and thermal conductivity. Moreover, the intermetallic phases influence recovery and recrystallisation processes and improve the thermal stability of the mechanical properties. Iron contents of more than 0.8 wt % promote the formation of coarse intermetallic phases, which may impair the formability in the deep drawing process. Iron contents of less than 0.2 wt %, on the other hand, limit the tolerance of the aluminium alloy for ferrous scrap too greatly since conventional scrap grades generally have a significant proportion of iron. Limiting the iron content too greatly may therefore hinder the achievement of high recycling rates. The corridor of the iron content of the aforementioned embodiment of 0.4 wt %≤Fe≤0.6 wt % therefore represents an ideal combination of recyclability, use of high proportions of recycled material, thermal stability, electrical and thermal conductivity and formability.

The copper content of the aluminium alloy is in the range of Cu≤0.3 wt % according to the invention. The fact that a copper content of up to 0.3 wt % is permitted results in an increased tolerance of the aluminium alloy for aluminium alloy scrap containing copper, which promotes the achievement of high proportions of recycled material in the manufacture of the battery cell housing. However, the presence of copper also causes an increase in the strength of the aluminium alloy through solid solution hardening, which must be limited for the battery cell housing lid material. A maximum copper content of Cu≤0.3 wt % guarantees sufficiently low cold hardening.

The manganese content of the aluminium alloy is in the range of Mn≤1.4 wt %. As already explained above, the manganese content of Mn≤1.4 wt % leads, in combination with the silicon and iron contents in the amounts specified, to the precipitation of particles of the quaternary α-Al(Fe, Mn)Si phase as well as the Al₆(Mn, Fe) phase. The intermetallic phases hinder recovery and recrystallisation processes and therefore improve the thermal stability of the mechanical properties. Manganese contents of more than 1.4 wt % promote the formation of coarse intermetallic phases, which have an unfavourable effect on forming properties.

The magnesium content of the aluminium alloy is preferably in the range of 0.005 wt %≤Mg≤0.8 wt %. In one embodiment of the battery cell housing lid, the magnesium content of the aluminium alloy is preferably in the range of 0.01 wt %≤Mg≤0.5 wt %, more preferably in the range of 0.01 wt %≤Mg≤0.3 wt %. The fact that a magnesium content of up to 0.8 wt % is permitted results in an increased tolerance of the aluminium alloy for aluminium alloy scrap containing magnesium such as UBC scrap, which further promotes the achievement of high proportions of recycled material in the manufacture of the battery cell housing lids. In addition, the presence of magnesium above a content of at least 0.01 wt % leads to efficient solid solution hardening, which contributes to increased cold hardening and therefore increases the strength. In this case, excessive cold hardening of the battery cell housing lid material is detrimental to pressure relief, meaning that a magnesium content of ≤0.8 wt %, preferably ≤0.5 wt %, and more preferably ≤0.3 wt % is suitable to prevent excessive cold hardening.

The chromium content of the aluminium alloy is preferably in the range of Cr≤0.25 wt %. In one embodiment of the battery cell housing lid, the chromium content of the aluminium alloy is in the range of Cr≤0.1 wt %. The fact that a chromium content of up to 0.25 wt % is permitted results in an increased tolerance of the aluminium alloy for chromium-containing aluminium alloy scrap, which promotes the achievement of high proportions of recycled material in the manufacture of the battery cell housings. In addition, chromium also has a strength-increasing effect and forms dispersoids, which increase the thermal stability and hinder softening due to recrystallisation or recovery. However, since excessively high chromium contents may have a detrimental effect on the electrical conductivity of the aluminium alloy, the chromium content is limited according to the invention to at most 0.25 wt %. For improved conductivity with a recycling tolerance and strength that are still sufficient, the chromium content in the aforementioned embodiment is limited to 0.1 wt %.

The zinc content of the aluminium alloy is preferably in the range of Zn≤0.4 wt %. The fact that a zinc content of up to 0.4 wt % is permitted results in an increased tolerance of the aluminium alloy for zinc-containing aluminium alloy scrap, which further promotes the achievement of high recycling rates. Zinc also has a strength-increasing effect. However, since excessively high zinc contents reduce the weldability, the electrical and thermal conductivity as well as the corrosion resistance of the aluminium alloy, the zinc content is preferably limited to at most 0.4 wt %.

The titanium content of the aluminium alloy is preferably in the range of Ti≤0.2 wt %. In one embodiment of the battery cell housing lid, the titanium content of the aluminium alloy is in the range of 0.005 wt %≤Ti≤0.1 wt %, preferably 0.005 wt %≤Ti≤0.05 wt %. The fact that a titanium content of up to 0.2 wt % is permitted results in an increased tolerance of the aluminium alloy for titanium-containing aluminium alloy scrap, which promotes the achievement of high proportions of recycled material in the manufacture of battery cell housing lids. Excessively high titanium contents may detrimentally affect the forming properties of the aluminium alloy and significantly reduce the electrical and thermal conductivities, however, so that the titanium content is limited to a maximum of 0.2 wt %.

In addition to the alloy composition mentioned above, the aluminium alloy of the battery cell housing lid comprises residual aluminium and unavoidable impurities. Unavoidable impurities are alloy constituents that are not intentionally added but are inevitably contained in the aluminium alloy due to manufacturing. The content of an individual unavoidable impurity is preferably limited to 0.05 wt %, with the content of all unavoidable impurities being limited to a total of 0.15 wt %. This ensures that the unavoidable impurities have no detrimental effect, or no significant detrimental effects, on the properties of the aluminium alloy, for example by undesired phase formation.

The increased Si and Fe contents in the preferred aluminium alloy for the battery cell housing lid contribute to good recycling potential. This also applies to the claimed Cu, Mn and Mg contents. At the same time, the preferred mechanical properties, for example a moderate to high yield strength with small uniform elongation A_{g} can be achieved in the preferred tempering states H24, H14, H18 or H19.

The battery cell housing can be used for any cylindrical battery format. However, particular advantages are achieved in battery cell housings with an internal radius of at least 7 mm, preferably at least 10 mm according to a preferred embodiment. In particular, the increase in the volume provided for the active material has a particularly significant effect on the storage capacity for larger formats, as the volume increases squarely with increasing radius.

The above-mentioned advantages apply to embodiments of the battery cell housing having a cup-shaped, cylindrical battery cell housing jacket with a battery cell housing base and a battery cell housing lid or having a tubular, cylindrical battery cell housing jacket with two battery cell housing lids. While cup-shaped battery cell housings only require one joining step to provide a closed battery cell housing but must be drawn in a cup shape for this purpose, a tubular battery cell housing jacket requires at least two joining operations at both ends to provide a closed battery cell housing.

The battery cell housing jacket preferably has no longitudinal weld seam, but has a seamless tube. Seamless tubes can, for instance, be produced through extrusion and/or drawing, exhibiting homogeneous properties in the circumferential direction and therefore lacking any potential “weak point” such as a weld seam. When using longitudinally welded tubes, at least three joining operations are required to provide the battery cell housing, but the material selection is greater here due to the manufacturing processes of the longitudinally welded tube. For longitudinally welded tubes, almost all weldable aluminium alloys can be considered as materials in any tempering state.

Optionally, in addition to the battery cell housing lid designed as a pressure relief means, at least one further pressure relief means, preferably at least one further bursting element, may be provided for axial pressure relief of the battery cell housing. This can further increase the protection of the battery cell housing against thermal runaway, as a further pressure relief means is provided. For example, a further pressure relief means of this type can be realised in the base of the cup-shaped battery cell housing, for example through embossing that locally reduces the wall thickness. Embossing can also be provided in the battery cell housing lid as a further pressure relief means. The embossing is preferably provided on the opposite side of the battery cell housing.

A battery cell housing that is particularly easy to manufacture is provided in a subsequent embodiment, wherein the battery cell housing includes a lid or a base with an opening for accommodating an electrical pole, preferably the anode of the battery cell, with the electrical pole being electrically insulated from the battery cell housing base and/or lid. The opening for the connection of the electrical pole can be created in the cup-shaped battery cell housing or in the sheet metal cut-out of the battery cell housing lid using simple punching techniques. The sheet metal cut-out can preferably be coated on one side with an electrically insulating layer to provide electrical insulation from the pole located inside the battery cell housing in a simple manner. The same can also be done for the battery cell housing jacket in order to insulate it electrically from the active material in a simple manner. For example, the electrical insulation can already be applied during aluminium strip production.

In order to make particularly good use of the available battery cell volume and provide a maximum battery cell capacity, according to one embodiment, the wall thicknesses of the material of the battery cell housing jacket are between 0.20 mm and 1.5 mm, preferably 0.3 mm to 1.2 mm and/or the wall thicknesses of the material of the battery cell housing lid are between 0.3 mm and 2.0 mm, preferably between 0.4 mm and 1.5 mm.

### BRIEF DESCRIPTION OF THE DRAWINGS

The invention is described in greater detail below using exemplary embodiments in connection with the drawing, In the drawing,

FIG. 1 shows a schematic sectional view of the structure of conventional battery cell housings,

FIG. 2 shows a schematic sectional view of a first exemplary embodiment of a battery cell housing according to the invention,

FIG. 3 shows an enlargement of the pole region of the battery cell housing from FIG. 2,

FIG. 4 shows a schematic sectional view of a second exemplary embodiment of a battery cell housing according to the invention, and

FIG. 5 shows an enlargement of the pole region of the battery cell housing from FIG. 4.

### DETAILED DESCRIPTION

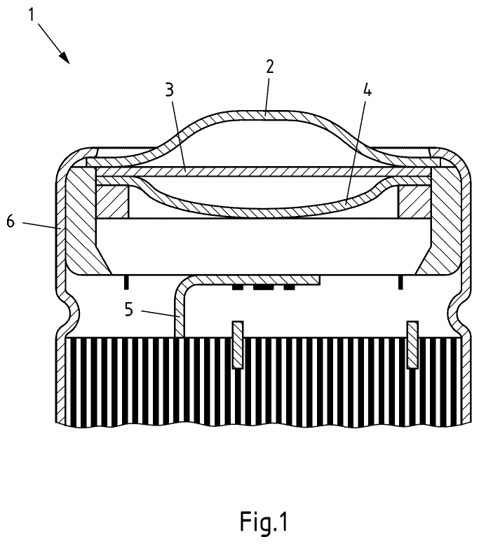

As previously explained, FIG. 1 is a schematic representation of a conventional battery cell housing 1 in a sectional view. The electrical contact 2 of the battery cell housing can be identified, which is connected to the battery electrode foil 5 by means of a PTC switch 3 and a current interruption disc 4, the latter of which also serves as a bursting disc for pressure relief. Not only is the assembly of this structure complex due to the double crimping, which is also prone to errors, but a relatively large volume of the battery cell housing 1 is also used for the safety devices. The battery cell housing jacket 6 of the conventional battery cell housing 1 usually consists of steel.

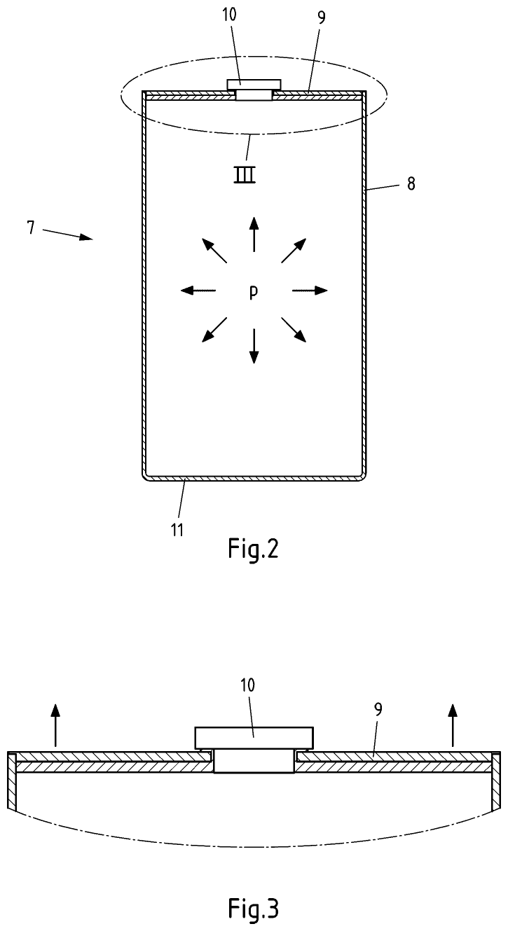

FIG. 2 also shows a schematic sectional view of an exemplary embodiment of a battery cell housing 7 according to the invention, with a battery cell housing jacket 8 having a first material made of an aluminium alloy and a battery cell housing lid 9 having a second material made of an aluminium alloy. An electrical contact 10 is provided in the battery cell housing lid 9 for contacting the battery cell, which contacts the battery electrode foil (not shown) through an opening in the battery cell housing lid 9. There is an internal pressure p inside the battery cell housing 7.

Unlike a conventional battery cell housing 1, the battery cell housing lid 9 in the battery cell housing 7 according to the invention is designed as a circular sheet metal cut-out and, in this exemplary embodiment, features an opening for the electrical contact 10. Furthermore, owing to its mechanical properties, the battery cell housing lid 9 is designed to serve as a pressure relief means for the battery cell housing 7, ensuring that if the permissible internal pressure of the battery cell is exceeded, only the battery cell housing lid 9 provides pressure relief in the axial direction. This preferably takes place at the edge of the battery cell housing lid 9 fastened to the battery cell housing jacket 8 since the greatest mechanical load is present there. FIG. 3 shows the direction of pressure relief in the event of a failure of the battery cell housing lid 9, showing an enlarged view of the battery cell housing lid 9 of the battery cell housing 7. For particularly high safety requirements, additional safety mechanisms such as burst beads or embossing can be incorporated into the battery cell housing lid 9 or the battery cell housing base 11 of the battery cell housing 7.

The preferred exclusive pressure relief through the battery cell housing lid 9 is achieved by ensuring that the material of the battery cell housing jacket 8 differs from the material of the at least one battery cell housing lid 9 in terms of the temper state of the aluminium alloy and/or the alloy composition.

Force-fitting connections between the battery cell housing lid 9 and the battery cell housing jacket 8 are also conceivable. Nevertheless, the at least one battery cell housing lid 9 is preferably materially bonded to the battery cell housing jacket 8 by means of a weld seam, preferably by means of a laser weld seam.

The internal pressure p at which the pressure relief through the battery cell housing lid 9 should occur is preferably 0.5 MPa to 2.5 MPa (5 bar to 25 bar), preferably 0.7 MPa to 2.0 MPa (7 bar to 20 bar), particularly preferably 0.7 MPa to 1.5 MPa (7 bar to 15 bar).

Since the battery cell housing jacket 8 should remain intact at these internal pressures, the battery cell housing jacket 8 preferably has a yield strength R_{p0.2} of more than 100 MPa, preferably more than 150 MPa, particularly preferably more than 180 MPa. Aluminium wrought alloys, preferably an aluminium alloy of type AA3xxx or of type AA5xxx, are used as preferred materials for the battery cell housing jacket 8. However, other aluminium wrought alloys with high mechanical yield strengths can also be considered.

A preferred aluminium alloy for the battery cell housing jacket 8 has the following alloy composition in wt %:
0.1%≤Si≤0.5%, preferably 0.2%≤Si≤0.4%,
0.20%≤Fe≤0.8%, preferably 0.40%≤Fe≤0.6%,
Cu≤0.6%, preferably 0.10%≤Cu≤0.30%,
0.3%≤Mn≤1.4%, preferably 0.50%≤Mn≤1.1%,
0.01%≤Mg≤1.5%, preferably 0.05%≤Mg≤1.30% or preferably 0.30%≤Mg≤1.20%,
Cr≤0.25%, preferably Cr≤0.1%,
Zn≤0.4%,
Ti≤0.2%, preferably 0.005 wt %≤Ti≤0.1 wt % or
preferably 0.005 wt %≤Ti≤0.05 wt %
the remainder being Al and unavoidable impurities, individually at most 0.05% and in total at most 0.15%.

The aluminium alloy of the battery cell housing jacket 8 offers a high recycling potential and delivers high strength alongside good formability and excellent corrosion resistance and weldability.

A further preferred aluminium alloy for the highest strength requirements of the battery cell housing jacket 8 has the following alloy composition in wt %:
Si<0.3%,
Fe<0.4%,
Cu<0.2%,
Mn<0.8%,
2.5%<Mg<6.0%, preferably 3%<Mg<6.0%,
Cr<0.2%,
Zn<0.25%,
Ti≤0.1%, preferably 0.001%≤Ti≤0.1%,
the remainder being Al and unavoidable impurities, individually at most 0.05% and in total at most 0.15%. It enables a further increase in the strength of the battery cell housing jacket, which can then also take on the tasks of a structural component.

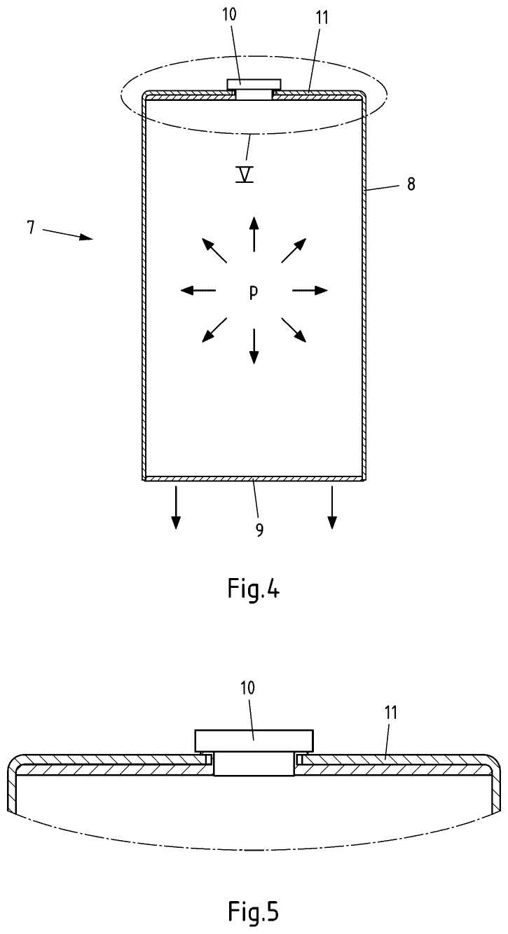

The exemplary embodiment from FIG. 2 has a battery cell housing lid 9 with an opening for carrying an electrical pole 10 of the battery cell. The exemplary embodiment in FIG. 4, on the other hand, has a battery cell housing base 11, which provides the opening for the electrical contact 10. In the exemplary embodiment shown in FIG. 4, the battery cell housing lid 9 is positioned opposite the electrical contact, allowing pressure relief through the battery cell housing lid 9 to occur in the direction opposite to that of the electrical contact 10. In both variants, however, the pressure relief takes place exclusively via the battery cell housing lid 9 such that it takes place in the axial direction of the battery cell housing 7 and thus prevents thermal runaway.

The wall thicknesses of the material of the battery cell housing jacket 8 in the present exemplary embodiments of FIGS. 2 and 4 are between 0.2 mm and 1.5 mm, preferably 0.3 mm to 1.2 mm, and/or the wall thicknesses of the material of the battery cell housing lid 9 are between 0.3 mm and 2.0 mm, preferably between 0.4 mm and 1.5 mm. This achieves sufficient internal pressure stability of the battery cell housing 7.

For a cylindrical battery cell housing 7, various alloys were examined using mechanical characteristic values in order to determine material combinations for battery cell housing jacket 8 and battery cell housing lid 9 which ensure exclusive pressure relief via the battery cell housing lid 9. As soon as the condition from equations (4a,b) was met, the material combination was marked as suitable.

To account for the anisotropy of the plastic properties of sheet materials as simply as possible, mean values (R_{p0.2})_{avg}; (Rₘ)_{avg}; and (A_{g})_{avg} for the yield strength R_{p0.2}, tensile strength Rₘ and uniform elongation A_{g} in the three directions of 0°, 45°, and 90° relative to the rolling direction are considered, in accordance with the relationship

$${X}_{avg} = \frac{1}{4} \cdot ( {X}_{{0}^{∘}} + 2 {X}_{{45}^{∘}} + {X}_{{90}^{∘}} )$$

known from sheet metal forming, whereby the value at 45° must be included twice in the calculation of the mean value and “X” serves as a placeholder for one of the parameters R_{p0.2}, Rₘ or A_{g}. All mechanical properties are specified or measured in accordance with DIN EN ISO 6892-1.

Table 2 shows the compatibility of different aluminium alloys with a battery cell housing jacket 8 having an aluminium alloy of type AA 3104 in temper state H19. As shown in Table 2, materials made from the aluminium alloy type AA3003 in the H24 or H14 state or the aluminium alloy AA1050-H19 are suitable for a pressure-relieving battery cell housing lid 9 when combined with the aluminium alloy type 3104 in the H19 state for the battery cell housing jacket 8, as these material combinations meet the conditions specified in equation (4a,b).

Irrespective of this result, for a battery cell housing of type 4680 with an inner radius Rᵢ of 23 mm, all materials in combination with the aluminium alloy AA3104-H19 for the battery cell housing jacket 8 ensure sufficient internal pressure stability of at least 8 bar, as shown in Table 3. The values for the permissible internal pressure pₚₑᵣₘ were determined using equation (14) using the specified wall thicknesses s_{D}=0.8 mm and s_{M}=0.75 mm. If other alloys are used as material for the battery cell housing jacket 8, different material combinations arise that are suitable for ensuring exclusive pressure relief via the battery cell housing lid. Combinations of the materials listed in Table 2 are considered, from which the values calculated in Tables 3a and 3b with equation (14) for the permissible internal pressure pₚₑᵣₘ for different materials of the battery cell housing jacket 8 were calculated using the wall thicknesses specified in Tables 3a and 3b. In all cases, pₚₑᵣₘ>0.5 MPa (5 bar) is guaranteed. A minimum of 0.7 MPa (7 bar) is not achieved by every material combination. The respective differences calculated for the combinations of the materials listed in Table 2 with equation (4b) are (R_{p0.2,avg})_{D,perm}−(R_{p0.2,avg})_{D} (R_{p0.2,avg})_{D,perm} summarised in Table 4 and Table 5. Only material combinations with a difference value greater than zero are considered suitable.

TABLE 2

| | | Directional | | | Maximum | | Exclusive |
|---|---|---|---|---|---|---|---|
| | | mean | | | permissible | Difference | Pressure |
| | | values | | | R_{p0.2} | (R_{p0.2, avg})ₚₑᵣₘ − | relief |
| | | R_{p0.2avg} | R_{m, avg} | A_{g, avg} | (R_{p0.2, avg})ₚₑᵣₘ | R_{p0.2, avg} | via the battery |
| Alloy | Temper | [MPa] | [MPa] | [%] | [MPa] | [MPa] | cell housing lid |
| 3104 | H19 | 279.3 | 301.2 | 2.93 | 279.3 | 0.00 | Jacket material |
| 3003 | H24 | 146.4 | 158.0 | 2.81 | 279.3 | 132.9 | Yes |
| 1050 | H19 | 167.5 | 177.8 | 1.83 | 279.3 | 111.8 | Yes |
| 3003 | H14 | 171.0 | 177.8 | 0.93 | 279.3 | 108.3 | Yes |
| 3005 | H14 | 182.9 | 192.8 | 1.48 | 279.3 | 96.4 | Yes |
| 5005 | H22 | 122.8 | 144.5 | 7.83 | 72.9 | −50.0 | No |
| 1050 | O | 46.1 | 84.8 | 31.03 | −30.0 | −76.1 | No |
| 3003 | O | 50.0 | 118.7 | 24.52 | −49.2 | −99.2 | No |
| 5182 | H48 | 389.5 | 415.4 | 1.67 | 279.3 | −110.2 | No |
| 3104 | H24 | 236.2 | 270.7 | 5.48 | 39.9 | −196.3 | No |
| 5182-G | O | 148.1 | 287.3 | 22.42 | −211.3 | −359.4 | No |

TABLE 3a

| | | LID MATERIAL | | | | | | | | | | |
|---|---|---|---|---|---|---|---|---|---|---|---|---|
| | | 3104- | 3003- | 1050- | 3003- | 3005- | 5005A- | 1050- | 3003- | 5182- | 3104- | 5182- |
| | | H19 | H24 | H19 | H14 | H14 | H22 | O | O | H48 | H24 | O |
| JACKET | 3104-H19 | 21.3 | 11.8 | 13.1 | 13.0 | 14.2 | 11.3 | 8.1 | 10.7 | 24.9 | 20.5 | 22.7 |
| MATERIAL | 3003-H24 | 15.5 | 11.2 | 11.8 | 11.8 | 12.3 | 11.0 | 8.1 | 10.7 | 18.0 | 14.8 | 16.5 |
| | 1050-H19 | 16.5 | 11.8 | 12.6 | 12.6 | 13.1 | 11.3 | 8.1 | 10.7 | 19.3 | 15.9 | 17.6 |
| | 3003-H14 | 16.7 | 11.8 | 12.8 | 12.7 | 13.3 | 11.3 | 8.1 | 10.7 | 19.5 | 16.0 | 17.8 |
| | 3005-H14 | 17.3 | 11.8 | 13.1 | 13.0 | 13.7 | 11.3 | 8.1 | 10.7 | 20.2 | 16.6 | 18.4 |
| | 5005A-H22 | 14.2 | 10.2 | 10.8 | 10.8 | 11.2 | 10.0 | 8.1 | 9.8 | 16.5 | 13.6 | 15.1 |
| | 1050-O | 8.7 | 6.3 | 6.6 | 6.6 | 6.9 | 6.1 | 5.2 | 6.0 | 10.1 | 8.3 | 9.2 |
| | 3003-O | 9.0 | 6.5 | 6.9 | 6.9 | 7.2 | 6.4 | 5.4 | 6.2 | 10.5 | 8.7 | 9.6 |
| | 5182-H48 | 22.5 | 11.8 | 13.1 | 13.0 | 14.2 | 11.3 | 8.1 | 10.7 | 29.4 | 20.7 | 25.5 |
| | 3104-H24 | 19.6 | 11.8 | 13.1 | 13.0 | 14.2 | 11.3 | 8.1 | 10.7 | 22.9 | 18.8 | 20.9 |
| | 5182-O | 15.5 | 11.2 | 11.9 | 11.8 | 12.3 | 11.0 | 8.1 | 10.7 | 18.1 | 14.9 | 16.6 |

Calculated permissible pressure pₚₑᵣₘ [bar] for the following geometric parameters of the battery cell: Rᵢ = 23 mm, s_{D} = 0.8 mm, s_{M} = 0.75 mm

TABLE 3b

| | | LID MATERIAL | | | | | | | | | | |
|---|---|---|---|---|---|---|---|---|---|---|---|---|
| | | 3104- | 3003- | 1050- | 3003- | 3005- | 5005A- | 1050- | 3003- | 5182- | 3104- | 5182- |
| | | H19 | H24 | H19 | H14 | H14 | H22 | O | O | H48 | H24 | O |
| JACKET | 3104-H19 | 26.6 | 14.7 | 16.4 | 16.2 | 17.7 | 14.1 | 10.0 | 13.4 | 31.0 | 25.5 | 28.3 |
| MATERIAL | 3003-H24 | 19.2 | 13.9 | 14.7 | 14.6 | 15.3 | 13.6 | 10.0 | 13.3 | 22.5 | 18.5 | 20.5 |
| | 1050-H19 | 20.6 | 14.7 | 15.7 | 15.7 | 16.4 | 14.1 | 10.0 | 13.4 | 24.0 | 19.8 | 21.9 |
| | 3003-H14 | 20.8 | 14.7 | 15.9 | 15.8 | 16.5 | 14.1 | 10.0 | 13.4 | 24.3 | 20.0 | 22.2 |
| | 3005-H14 | 21.5 | 14.7 | 16.4 | 16.2 | 17.1 | 14.1 | 10.0 | 13.4 | 25.1 | 20.6 | 22.9 |
| | 5005A-H22 | 17.6 | 12.8 | 13.5 | 13.4 | 14.0 | 12.5 | 10.0 | 12.2 | 20.6 | 16.9 | 18.8 |
| | 1050-O | 10.8 | 7.8 | 8.3 | 8.2 | 8.6 | 7.7 | 6.5 | 7.5 | 12.6 | 10.4 | 11.5 |
| | 3003-O | 11.2 | 8.1 | 8.6 | 8.6 | 8.9 | 8.0 | 6.7 | 7.8 | 13.1 | 10.8 | 12.0 |
| | 5182-H48 | 28.0 | 14.7 | 16.4 | 16.2 | 17.7 | 14.1 | 10.0 | 13.4 | 36.6 | 25.8 | 31.8 |
| | 3104-H24 | 24.4 | 14.7 | 16.4 | 16.2 | 17.7 | 14.1 | 10.0 | 13.4 | 28.5 | 23.5 | 26.0 |
| | 5182-O | 19.4 | 14.0 | 14.8 | 14.7 | 15.4 | 13.7 | 10.0 | 13.4 | 22.6 | 18.6 | 20.6 |

Calculated permissible pressure pₚₑᵣₘ [bar] for the following geometric parameters of the battery cell: Rᵢ = 10.5 mm, s_{D} = 0.45 mm, s_{M} = 0.35 mm

TABLE 4

| | | LID MATERIAL | | | | | | | | | | |
|---|---|---|---|---|---|---|---|---|---|---|---|---|
| | | 3104- | 3003- | 1050- | 3003- | 3005- | 5005A- | 1050- | 3003- | 5182- | 3104- | 5182- |
| | | H19 | H24 | H19 | H14 | H14 | H22 | O | O | H48 | H24 | O |
| JACKET | 3104-H19 | 0.0 | 132.9 | 111.8 | 108.3 | 96.4 | −50.0 | −76.0 | −99.2 | −110.2 | −196.3 | −359.4 |
| MATERIAL | 3003-H24 | −289.1 | 0.0 | −21.1 | −24.6 | −36.5 | −158.2 | −103.4 | −133.8 | −292.0 | −350.9 | −397.2 |
| | 1050-H19 | −364.7 | −79.0 | 0.0 | −3.5 | −15.4 | −186.5 | −110.5 | −142.8 | −425.1 | −391.4 | −407.1 |
| | 3003-H14 | −469.5 | −188.5 | −167.7 | 0.0 | −155.1 | −225.8 | −120.4 | −155.4 | −609.6 | −447.5 | −420.8 |
| | 3005-H14 | −391.6 | −107.1 | −42.9 | 11.9 | 0.0 | −196.6 | −113.1 | −146.1 | −472.4 | −405.8 | −410.6 |
| | 5005A-H22 | −156.5 | −23.6 | −44.7 | −48.2 | −60.1 | 0.0 | −63.4 | −83.3 | −266.7 | −124.9 | −341.9 |
| | 1050-O | −233.3 | −100.3 | −121.4 | −124.9 | −136.8 | −76.8 | 0.0 | −3.9 | −343.4 | −190.1 | −254.1 |
| | 3003-O | −229.3 | −96.4 | −117.5 | −121.0 | −132.9 | −72.8 | 2.3 | 0.0 | −339.5 | −186.2 | −250.9 |
| | 5182-H48 | −123.2 | 173.3 | 222.0 | 218.5 | 206.6 | −96.1 | −87.7 | −113.9 | 0.0 | −262.2 | −375.5 |
| | 3104-H24 | −43.2 | 89.8 | 68.7 | 65.2 | 53.3 | 87.4 | −41.4 | −55.3 | −153.3 | 0.0 | −311.4 |
| | 5182-O | −131.3 | 1.7 | −19.4 | −22.9 | −34.8 | 25.2 | 102.0 | 98.1 | −241.4 | −88.1 | 0.0 |

The numerical values correspond to the difference (R_{p0.2, avg})_{D, perm} − (R_{p0.2, avg})_{D} [MPa] of the respective material combination.

TABLE 5

| | | LID MATERIAL | | | | | | | | | | |
|---|---|---|---|---|---|---|---|---|---|---|---|---|
| | | 3104- | 3003- | 1050- | 3003- | 3005- | 5005A- | 1050- | 3003- | 5182- | 3104- | 5182- |
| | | H19 | H24 | H19 | H14 | H14 | H22 | O | O | H48 | H24 | O |
| JACKET | 3104-H19 | Not OK | According | According | According | According | Not OK | Not OK | Not OK | Not | Not | Not |
| MATERIAL | | | to the | to the | to the | to the | | | | OK | OK | OK |
| | | | invention | invention | invention | invention | | | | | | |
| | 3003-H24 | Not OK | Not OK | Not OK | Not OK | Not OK | Not OK | Not OK | Not OK | Not | Not | Not |
| | | | | | | | | | | OK | OK | OK |
| | 1050-H19 | Not OK | Not OK | Not OK | Not OK | Not OK | Not OK | Not OK | Not OK | Not | Not | Not |
| | | | | | | | | | | OK | OK | OK |
| | 3003-H14 | Not OK | Not OK | Not OK | Not OK | Not OK | Not OK | Not OK | Not OK | Not | Not | Not |
| | | | | | | | | | | OK | OK | OK |
| | 3005-H14 | Not OK | Not OK | Not OK | According | Not OK | Not OK | Not OK | Not OK | Not | Not | Not |
| | | | | | to the | | | | | OK | OK | OK |
| | | | | | invention | | | | | | | |
| | 5005A-H22 | Not OK | Not OK | Not OK | Not OK | Not OK | Not OK | Not OK | Not OK | Not | Not | Not |
| | | | | | | | | | | OK | OK | OK |
| | 1050-O | Not OK | Not OK | Not OK | Not OK | Not OK | Not OK | Not OK | Not OK | No | Not | Not |
| | | | | | | | | | | OK | OK | OK |
| | 3003-O | Not OK | Not OK | Not OK | Not OK | Not OK | Not OK | According | Not OK | Not | Not | Not |
| | | | | | | | | to the | | OK | OK | OK |
| | | | | | | | | invention | | | | |
| | 5182-H48 | Not OK | According | According | According | According | Not OK | Not OK | Not OK | Not | Not | Not |
| | | | to the | to the | to the | to the | | | | OK | OK | OK |
| | | | invention | invention | invention | invention | | | | | | |
| | 3104-H24 | Not OK | According | According | According | According | According | Not OK | Not OK | Not | Not | Not |
| | | | to the | to the | to the | to the | to the | | | OK | OK | OK |
| | | | invention | invention | invention | invention | invention | | | | | |
| | 5182-O | Not OK | According | Not OK | Not OK | Not OK | According | According | According | Not | Not | Not |
| | | | to the | | | | to the | to the | to the | OK | OK | OK |
| | | | invention | | | | invention | invention | invention | | | |

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Cylindrical battery cell housing of a battery cell having a battery cell housing jacket having a cylindrical cross-section in at least some areas, having a first material made of an aluminium alloy,
wherein
the battery cell housing jacket is connected to at least one battery cell housing lid having a second material made of an aluminium alloy in a force-fitting and/or materially bonded manner, wherein the at least one battery cell housing lid is shaped as a sheet metal cut-out, and this sheet metal cut-out serves as a pressure relief means for the battery cell housing due to its mechanical properties, such that if a permissible internal pressure (p) of the battery cell is exceeded, the at least one battery cell housing lid ensures pressure relief of the battery cell in the axial direction, whereby the mechanical properties of the sheet metal blank are determined by the composition of the aluminium alloy and the temper of the sheet metal blank.

2. Battery cell housing according to claim 1,
wherein
the first material of the battery cell housing jacket differs from the second material of the at least one battery housing lid in terms of the temper state of the aluminium alloy and/or in terms of the alloy composition.

3. Battery cell housing according to claim 1,
wherein
the at least one battery cell housing lid is materially bonded to the battery cell housing jacket via a weld seam, preferably a laser weld seam.

4. Battery cell housing according to claim 1,
wherein
the yield strength (R_{p0.2})_{D} of the material of the at least one battery cell housing lid meets the condition
$${( {R}_{p 0.2} )}_{D} < min \{ {( {R}_{p 0.2} )}_{M} ; {( {R}_{p 0.2} )}_{M} \cdot ( \frac{{( {A}_{g} )}_{M}}{{( {A}_{g} )}_{D}} ) + \frac{{( {R}_{m} \cdot {A}_{g} )}_{M} - {( {R}_{m} \cdot {A}_{g} )}_{D}}{{( {A}_{g} )}_{D}} \} ,$$
where
(R_{p0.2})_{M}: Yield strength of the battery cell housing jacket,
(A_{g})_{M}: Uniform elongation of the battery cell housing jacket,
(A_{g})_{D}: Uniform elongation of the battery cell housing lid,
(Rₘ·A_{g})_{M}: Product of tensile strength and uniform elongation of the battery cell housing jacket.
(Rₘ·A_{g})_{D}: Product of tensile strength and uniform elongation of the battery cell housing lid.

5. Battery cell housing according to claim 1,
wherein
the following applies to the wall thickness s_{D} of the battery cell housing lid:
$${s}_{D} = \sqrt{\frac{3}{4} \cdot \frac{{R}_{i}^{3}}{{s}_{M}}} \cdot ( \frac{{p}^{*}}{min \{ {( {R}_{m} \cdot ( 1 + {A}_{g} ) )}_{D} ; \sqrt{{( {R}_{m} \cdot ( 1 + {A}_{g} ) )}_{D} \cdot {( {R}_{p 0.2} )}_{M}} \}} )$$
where
s_{M}: Wall thickness of the battery cell housing jacket,
s_{D}: Wall thickness of the battery cell housing lid,
p*: Specified internal pressure in the battery cell housing at the time of failure of the lid,
D: Index of the battery cell housing lid
M: Index of the battery cell housing jacket.

6. Battery cell housing according to claim 1,
wherein
the battery cell housing lid provided for pressure relief activates the pressure relief of the battery cell housing at an internal pressure ranging from 0.5 MPa to 2.5 MPa, preferably from 0.7 MPa to 2.0 MPa, and particularly preferably from 0.7 MPa to 1.5 MPa.

7. Battery cell housing according to claim 1,
wherein
the battery cell housing jacket has a yield strength R_{p0.2} of more than 100 MPa, preferably 150 MPa, particularly preferably more than 180 MPa.

8. Battery cell housing according to claim 1,
wherein
the battery cell housing jacket has an aluminium wrought alloy, preferably an aluminium wrought alloy of type AA3xxx or of type AA5xxx.

9. Battery cell housing according to claim 1,
wherein
the battery cell housing jacket has an aluminium alloy having the following alloy composition in wt %:
0.1%≤Si≤0.5%, preferably 0.2%≤Si≤0.4%,
0.20%≤Fe≤0.8%, preferably 0.40%≤Fe≤0.6%,
Cu≤0.6%, preferably 0.10%≤Cu≤0.30%,
0.3%≤Mn≤1.4%, preferably 0.50%≤Mn≤1.1%,
0.01%≤Mg≤1.5%, preferably 0.05%≤Mg≤1.30%, or
preferably 0.30%≤Mg≤1.20%,
Cr≤0.25%, preferably Cr≤0.1%,
Zn≤0.4%,
Ti≤0.2%, preferably 0.005 wt %≤Ti≤0.1 wt % or preferably 0.005 wt %≤Ti≤0.05 wt %,
the remainder being Al and unavoidable impurities, individually at most 0.05% and in total at most 0.15%.

10. Battery cell housing according to claim 1,
wherein
the battery cell housing jacket has an aluminium alloy having the following alloy composition in wt %:
Si<0.3%,
Fe<0.4%,
Cu<0.2%,
Mn<0.8%,
2.5%<Mg<6.0%, preferably 3%<Mg<6.0%,
Cr<0.2%,
Zn<0.25%,
Ti≤0.15%, preferably 0.001%≤Ti≤0.1%,
the remainder being Al and unavoidable impurities, individually at most 0.05% and in total at most 0.15%.

11. Battery cell housing according to claim 1,
wherein
the at least one battery cell housing lid has an aluminium wrought alloy of the type AA1xxx, AA8xxx, or AA3xxx, wherein the material of the battery cell housing lid is preferably in the temper state H24, H14, H18 or H19.

12. Battery cell housing according to claim 1,
wherein
the battery cell housing lid has an aluminium alloy having the following alloy composition in wt %:
0.1%≤Si≤0.5%,
Fe≤0.8%, preferably 0.20%≤Fe≤0.8%,
Cu≤0.3%,
Mn≤1.4%,
0.005%≤Mg≤0.8%, preferably 0.01%≤Mg≤0.5%,
more preferably 0.01%≤Mg≤0.3%,
Cr≤0.25%,
Zn≤0.4%,
Ti≤0.2%,
the remainder being Al and unavoidable impurities, individually at most 0.05% and in total at most 0.15%.

13. Battery cell housing according to claim 1,
wherein
the battery cell housing has an inner radius of at least 15 mm, preferably at least 18 mm.

14. Battery cell housing according to claim 1,
wherein
the battery cell housing has a cup-shaped, cylindrical battery cell housing jacket with a battery cell housing base and a battery cell housing lid or has a tubular, cylindrical battery cell housing jacket with two battery cell housing lids, wherein optionally, in addition to the battery cell housing lid lid formed as a pressure relief means, at least one further pressure relief means, preferably at least one further bursting element, is provided for axial pressure relief of the battery cell housing.

15. Battery cell housing according to claim 1,
wherein
the battery cell housing has a battery cell housing lid or a battery cell housing base with an opening for an electrical pole of the battery cell, wherein the electrical pole is electrically insulated from the battery cell housing base and/or lid.

16. Battery cell housing according to claim 1,
wherein
the wall thicknesses of the material of the battery cell housing jacket are between 0.2 mm and 1.5 mm, preferably 0.3 mm to 1.2 mm and/or the wall thicknesses of the material of the battery cell housing lid are between 0.3 mm and 2.0 mm, preferably between 0.4 mm and 1.5 mm.
